(19) United States
(12) Patent Application Publication
(10) Pub. No.: US 2012/0173968 A1
(43) Pub. Date: Jul. 5, 2012

(54) Bullet Point News Reporting

(76) Inventor: Chi Kuen Ip, (US)

(21) Appl. No.: 12/983,308

(22) Filed: Jan. 2, 2011

(51) Int. Cl. G06F 17/00

(52) U.S. Cl. 715/243

(57) ABSTRACT

The invention is a method of publishing news that is based solely on the use of bullet points, indentations and categories. It is meant to be a substitute and replacement for the standard paragraph-format news article. All statements, facts, details, statistics, quotes, and other units of information are placed into bullet points as opposed to written out in sentences in a paragraph. Bullet points are indented at varying levels to signify what type, and category of information it is, creating a parent-child, hierarchical relationship between bullet points and categories. Another characteristic of Bullet Point News Reporting is the elimination of all words, characters, and formatting that does not immediately serve the purpose of providing fact or comprehension in an attempt to remove author bias, author opinion, or author commentary.

### BACKGROUND OF THE INVENTION

The invention relates to the field of written news articles and the way they are written and published, be it on the internet, newspaper, brochures, pamphlets, computer, iPad or any other medium of written and printed text. Currently, all articles are written like a story. Current news articles start off with a broad paragraph describing the news in brief, and then go on to discuss the story, incidents, personnel, quotations, people and other aspects of the story in further detail in paragraph format, like an essay. Each new paragraph begins with a general sentence that describes what that paragraph will be about and then the rest of the paragraph goes into detail on the statements made in the first sentence.

The problem with this way of writing and reporting news is that it makes the articles unnecessarily long, invites commentary from the author, invites bias from the author, and it invites the possibility of skewing facts. It prevents the reader from seeing just the facts, the user has to spend brain power picking through colorful words added by the author to get the facts. Readers have to sort out the opinions, commentary, and bias of the author manually, often resulting in not completely reading the article and missing many details.

The object of my invention is to eliminate the above drawbacks, and thereby to provide a way to write news articles that are devoid of excess and unnecessary wording.

The main object of my invention is to make news article faster, more precise, and easier to read.

Another object of my invention is to eliminate the need to skip through articles to filter out the facts.

A further object of my invention is to eliminate the possibility of author commentary, bias, and opinion in the reporting of news.

No specific prior art exists that can or is capable of doing all of the listed above except my invention.

### SUMMARY OF THE INVENTION

The main component of Bullet Point News Reporting is that the article is not written in conventional essay format, but rather using bullet points to single out individual statements, facts, quotes, statistics, or details. By doing this, articles are easier to read, quicker to read, and author bias, commentary, and opinion is removed.

Bullet Point News Reporting according to the present invention begins with a Main Heading that briefly describes the Bullet Point News Reporting article that follows. The first group of bullet points is any statements, facts, quotes, statistics, or details that give a general overview of the entire report. If the report is short, the information in the first group of bullet points is satisfactory and the report is over. The number of bullet points in a story is dependent on how many statements, facts, quotes, statistics or details are available at that time. These change as more details from the story become available.

If there are more facts to report than just the first group of general overview bullet points, then categories of information are added. They are added by displaying a word, place, thing, person, fact, statistic, detail or statement in bold, about what the new category of information is about (called a category heading). The category heading is not in a bullet point. Following the category heading are more statements, facts, quotes, statistics or details concerning the new category of information related to the story, in bullet point format.

At any point in the Bullet Point News Reporting article, bullet points are indented to signify that they are related to a previously stated statement, fact, quote, statistics or detail. The use of indentation in a Bullet Point News Reporting article signifies a parent—child relationship between the different bullet points and category headings. For example, if there are 5 quotes by the same person, instead of manipulating the person's intended meaning of the quote by dispersing them throughout the article, which is what current news articles do, a Bullet Point News Reporting article lists the person who said these quotes as a category heading, and then his quotes would be listed in indented bullet points underneath (to signify that those quotes belong to the person listed in the category heading).

Also at chosen points in the Bullet Point News Reporting article, a bullet point that contains a statement, fact, quote, statistic or detail acts as a category heading in itself. It does this by being in bold, or half in bold and being followed by more bullet points of statement, fact, quote, statistic or detail in indentation on the following line or lines.

A bullet point including a statement, fact, quote, statistics or detail appears at any point or place in the Bullet Point News Reporting format. A bullet point is not required to be under a category heading.

All current news providers publish news stories or articles with large bodies of dense text in essay-like format. Coincidentally, this format of writing with large bodies of text is also appropriately nicknamed the “news article” format. The problem is that they are difficult to read, very cluttered, and include commentary, bias, and opinion of the author, inadvertently or not.

The objects of Bullet Point News Reporting are to make articles easier to read, faster to read, easier to comprehend, eliminate author bias, eliminate author commentary, and eliminate author opinion.

Bullet Point News Reporting is able to eliminate author opinion, commentary, and bias by using bullet points to display only the most relevant key statements, facts, quotes, statistics or details. Bullet Point News Reporting is able to do this by eliminating all verbiage that does not immediately contribute to the comprehension, and fact producing ability of the news story, it is able to do this and maintain cohesion by its use of bullet points.

The Bullet Point News Reporting method of publishing news articles is unobvious and novel because nobody, individual or entity, has ever published, or is publishing articles in this bullet point format. No other individual or entity is publishing any variant that is even similar in nature to this format. If it was obvious, somebody would already be doing it. Having said that, my website called the Bullet News Network (BNN.cm) is the first to publish articles in Bullet Point News Reporting format, and is the only news source doing so as of the date of this filing.

### BRIEF DESCRIPTION OF THE DRAWINGS

FIG. 1 is a depiction of an article featuring Bullet Point News Reporting formatting. The picture clearly depicts the Main Heading, bullet points that include statements, facts, quotes, statistics or details, category headings and indentations that signify parent-child relationships between bullet points, category headings and other bullet points.

FIG. 2 is a depiction of an article featuring Bullet Point News Reporting formatting. The picture clearly depicts the Main Heading, bullet points that include statements, facts, quotes, statistics or details, category headings and indentations that signify parent-child relationships between bullet points, category headings and other bullet points.

FIG. 3 is a depiction of an article featuring Bullet Point News Reporting formatting. The picture clearly depicts the Main Heading, bullet points that include statements, facts, quotes, statistics or details, category headings and indentations that signify parent-child relationships between bullet points, category headings and other bullet points.

### DETAILED DESCRIPTION OF THE INVENTION

Bullet Point News Reporting (hereafter referred to as BPNR) is the method of writing a news article in hierarchies of statements, facts, quotes, statistics or details by using bullet points that are further divided into categories instead of the conventional essay or story format.

To create an article that utilizes BPNR, the author begins by gathering all of his facts in the same way as a regular article. The difference lies in how the article is written. Articles written in BPNR do not contain any traditional paragraphs, and sentences, but are organized by bullet points, into categories and levels of hierarchy.

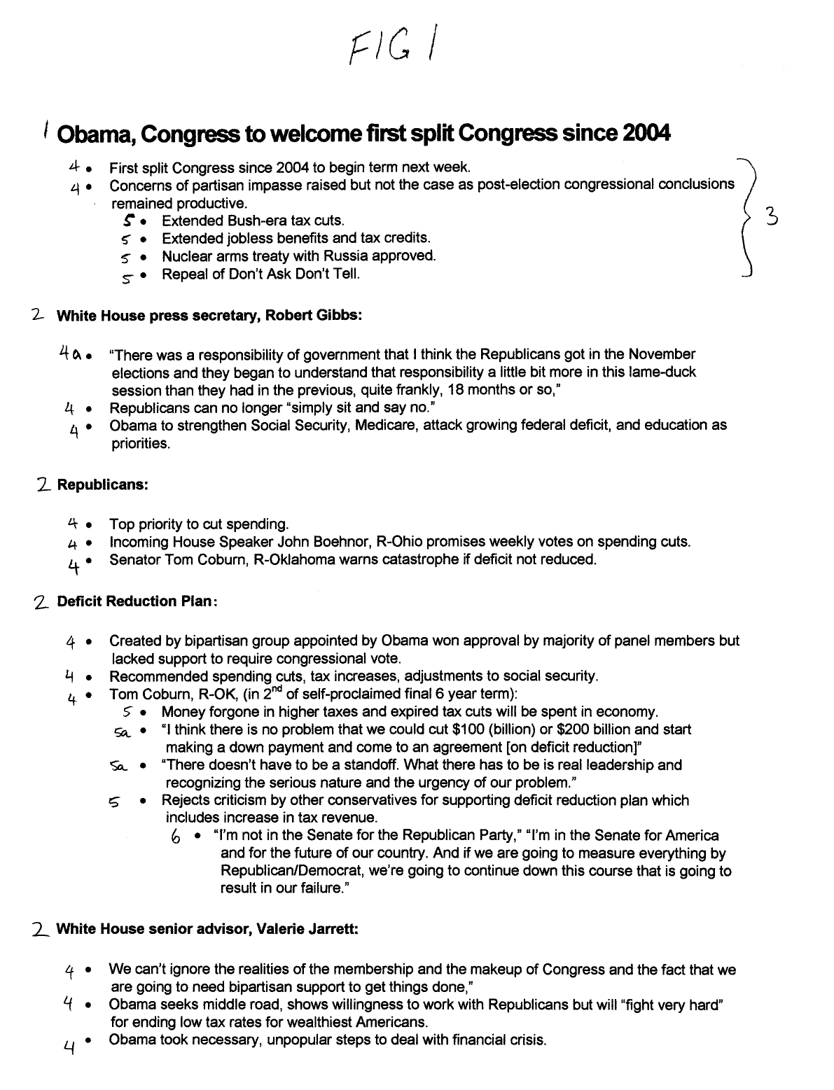

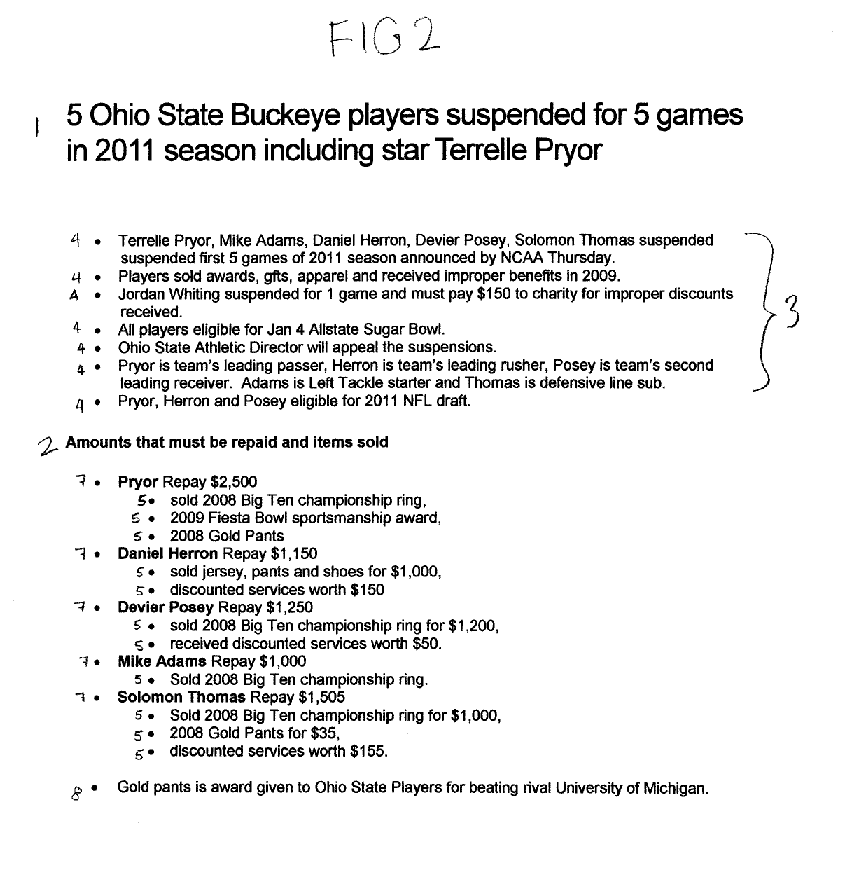

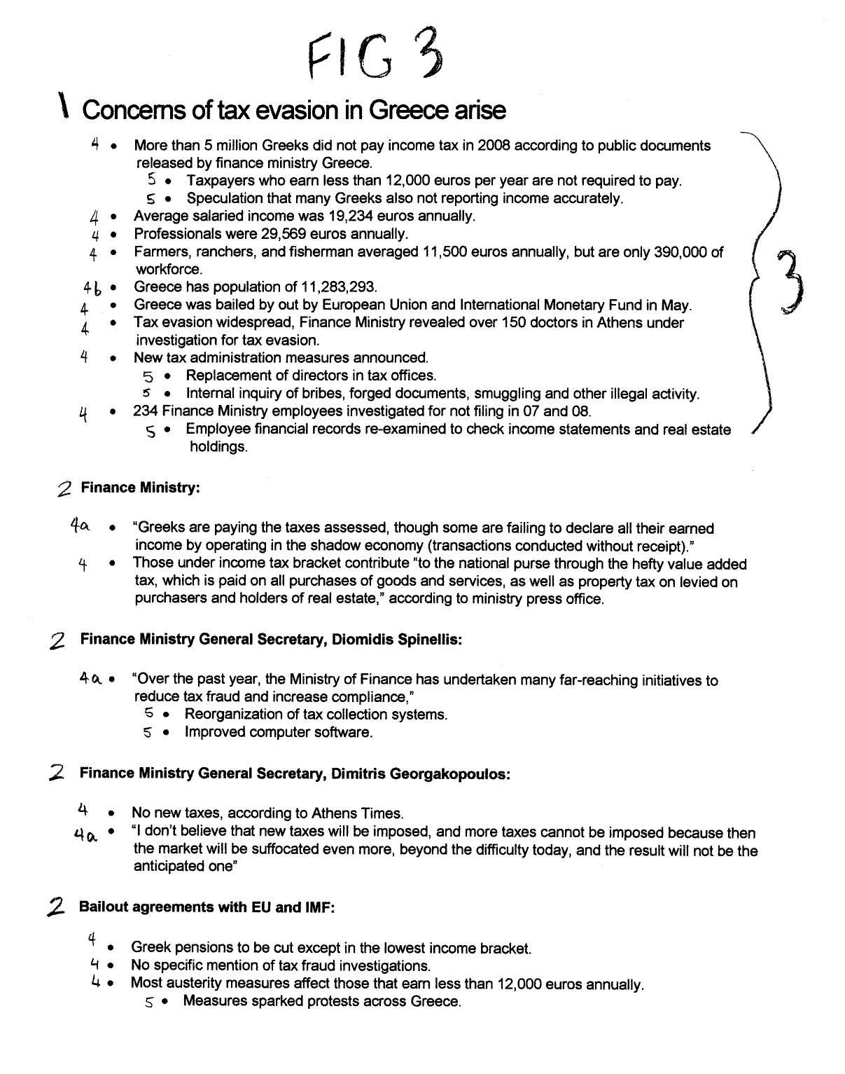

Referring now to elements in FIG. 1, FIG. 2, and FIG. 3, the author begins by creating a Main Heading (1). This Main Heading is the main topic of the BPNR article; by reading this portion of the BPNR article, the reader will have an understanding of the topic before he even begins.

The next part of the BPNR article is the more detailed general overview (3) of the article. Like the rest of the article, it must be formatted by the use of bullet points. By using bullet points instead of simply writing in paragraph format, the article is much easier to use, easier on the eye, and easier to comprehend the facts of the story. Depending on whether or not there is more information that is derived from a bullet point in the general overview, the author indents a bullet point to signify a parent—child relationship between one or more bullet points and the originating bullet point (5). This means that the author has additional information that is directly related to a previous point made in a bullet point.

The author indents even further to show a statement, fact, quote, statistic or detail as a ‘child’ (derived from) of another statement that has already been indented (6). This opens up another level of hierarchy that tells the reader which bullet points are derived from which statement, fact, quote, statistic or detail. There are no limitations to how many indentations or levels of hierarchy are created.

These indentations (5, 6) are placed anywhere in the article that they are needed to show a statement, fact, quote, statistic, or detail as being derived from another.

The next element of a BPNR article is the Category Heading (2). This part of the BPNR article details what the group of bullet points immediately following the category heading will be about. The category heading is a word, place, thing, person, fact, statistic, detail or statement. This element of the BPNR article is the second highest ranking heading besides the Main Heading (1) and indicates that a specific group of bullet points all relate in some way to the topic in that category heading.

The author then writes the main bullet points (4, 7) of the BPNR article. The article depends on these bullet points to relay information to the reader. These bullet points contain anything pertaining to the story, whether it is a statement, fact, quote, statistic or detail. A bullet point that contains a quote on various levels of indentation and hierarchy is shown on FIGS. 1 as (4a), (5a), and (6), and FIG. 3 as (4a). A bullet point that contains a statistic is shown on FIG. 3 as (4b). A main bullet point is bolded to indicate higher importance (7). Bullet points that stand by themselves (8 in FIG. 2) signify that they are outlier pieces of information that do not fit in any specific category but help bring the overall article into a complete view for better understanding.

One uses the invention by reading the final product (said product being an article written in BPNR format) it in print (soft or hard copy) when it is published. The reader spends roughly 35% less time reading a BPNR article than reading a regular article because the bullet points utilized in BPNR enable words to be cut where they would otherwise be needed for comprehension in a regular article. Despite this heavy truncation of text, a BPNR article written according to the method outlined in these specifications contains the same amount of factual information as non-BPNR news articles. If the average American reads an hours of news a day, reading articles written in BPNR format would save every American up over 128 hours a year. If everyone in the United States read articles in BPNR format, it would save them more than 39 billion hours a year, or over 107 million hours a day.

There is nothing else that has been created, implemented, capable or even similar to what BPNR is capable of in its ability to provide news that is not cluttered, fast to read, and free of author opinion, commentary and bias.

I claim:

1. A bullet point news reporting method of publishing news articles comprising:
creating an article using bullet points as a main method of displaying information, statements, facts, quotes, statistics or details.

2. The method of claim 1 wherein said article contains one or more category headings, defined as a word, subject, statement, fact, statistic, quote, person, detail, place, or grouping, that indicates that a section immediately following a category heading is about a specific topic.

3. The method of claim 1 wherein said bullet points that relate to a same topic, grouping, subject, statement, fact, statistic, quote, person, detail, place, or thing are categorized and grouped together under a category heading that lists the topic of what the grouping is.

4. The method of claim 1 wherein said bullet points are indented to signify that one or more of an indented bullet point is directly related to a bullet point or category heading that immediately precedes the indented bullet points.

5. The method of claim 1 wherein said article contains one or more category headings, defined as a word, subject, statement, fact, statistic, quote, person, detail, place, or grouping, that indicates that the section immediately following the category heading is about the stated topic and that said bullet points that relate to the same topic, grouping, subject, statement, fact, statistic, quote, person, detail, place, or thing are categorized and grouped together under the category heading that lists the topic of what the grouping is.

6. The method of claim 1 wherein said article contains one or more category headings, defined as a word, subject, statement, fact, statistic, quote, person, detail, place, or grouping, that indicates that the section immediately following the category heading is about the stated topic and that said bullet points are indented to signify that one or more of the indented bullet points are directly related to the bullet point or category heading that immediately precedes the indented bullet points.

7. The method of claim 1 wherein said bullet points are indented to signify that one or more of the indented bullet points are directly related to the bullet point or category heading that immediately precedes the indented bullet points and that said bullet points that relate to the same topic, grouping, subject, statement, fact, statistic, quote, person, detail, place, or thing are categorized and grouped together under the category heading that lists the topic of what the grouping is.

8. A bullet point news reporting method of publishing news articles comprising:
creating an article using bullet points as the main method of displaying information, statements, facts, quotes, statistics or details;
creating one or more category headings, defined as a word, subject, statement, fact, statistic, quote, person, detail, place, or grouping, that indicates that the section immediately following a category heading is about the stated topic;
creating bullet points that relate to the same topic, grouping, subject, statement, fact, statistic, quote, person, detail, place, or thing are categorized and grouped together under the category heading that lists the topic of what the grouping is; and
creating bullet points that are indented to signify that one or more of the indented bullet points are directly related to the bullet point or category heading that immediately precedes the indented bullet points.
